(19) United States
(12) Patent Application Publication
(10) Pub. No.: US 2024/0209995 A1
(43) Pub. Date: Jun. 27, 2024

(54) LIGHTING DEVICE AND METHOD FOR THE PRODUCTION THEREOF

(71) Applicant: Hella GmbH & Co. KGaA, Lippstadt (DE)

(72) Inventors: Ana Bizal, Domzale (SI); Jürgen Griebel, Steinen (DE); Simon Lützelschwab, Rheinfelden (DE); Matthias Merkel, Schwörstadt/Dassenbach (DE); Vinzenz Sandfort, Zell im Wiesenthal (DE); Heiko Schöne, Zell im Wiesenta (DE)

(21) Appl. No.: 18/596,243

(22) Filed: Mar. 5, 2024

Related U.S. Application Data
(63) Continuation of application No. PCT/EP2022/073386, filed on Aug. 23, 2022.

(30) Foreign Application Priority Data
Sep. 8, 2021 (DE) 10 2021 123 278.3

(51) Int. Cl. F21K 9/61; F21K 9/90; F21K 9/69; F21W 106/00

(52) U.S. Cl. CPC F21K 9/61; F21K 9/90; F21K 9/69; F21V 2200/17; F21W 2106/00

(57) ABSTRACT

A method is provided for the production of a lighting device, and the lighting device is also provided for lighting an interior. The device has at least one cylindrical longitudinal segment, at least one lateral segment that extends away from the longitudinal segment, and at least one light source. The at least one longitudinal segment has at least one light entry surface along its length, and at least one light transfer region through which light is conducted into the lateral segment. The at least one lateral segment is flat, and contains at least one light-conducting fiber through which light is emitted into the interior. The at least one light-conducting fiber is materially bonded to the at least one longitudinal segment to form the light transfer region. This results in a simple, quick and inexpensive production, with a mechanically durable connection, which results in a homogenous light distribution.

### CROSS REFERENCE

This application claims priority to PCT Application No. PCT/EP2022/073386, filed Aug. 23, 2022, which itself claims priority to German Application No. 10 2021 123278.3, filed Sep. 8, 2021, the entireties of both of which are hereby incorporated by reference.

### FIELD OF THE INVENTION

The invention relates to a lighting device for an interior, containing at least one cylindrical longitudinal segment, at least one lateral segment extending away from the longitudinal segment, and at least one light source, in which there is at least one light entry surface along the longitudinal segment for the light from the at least one light source, and at least one light transfer region that conducts the light into the lateral segment. The at least one light entry surface has a dedicated light source and is opposite the transfer region. The at least one lateral segment is flat, and contains at least one light-conducting fiber with which the light is emitted into the interior. The light-conducting fiber has two ends.

The invention also relates to a method for the production of the lighting device.

### BACKGROUND OF THE INVENTION

There are forms of interior lighting in the prior art that make use of fiber-optics, in particular for vehicle interiors. Ever since reliable and powerful LEDs have been available, light from monochromatic LEDs or multi-colored LEDs has usually been used to obtain a variety of ambient lighting effects. Because they require little space and are energy efficient, they are ideal for flat lighting systems for door panels or ceiling upholstery. The light distribution is primarily apparent to vehicle passengers, for which reason a homogenous light distribution is of increasing importance.

DE 10 2016 218 326 A1 discloses a lighting device which has a light entry segment for the light from an LED light source containing a diffusing material between the LED unit and the light entry surface on the optical fiber, with which a homogenous light distribution of a uniform color is obtained. To connect the light entry segment to the optical fiber, the light entry segment has a cylindrical fitting for the end of the optical fiber.

The disadvantage with this is the connection between the optical fiber and the light entry segment. This is not only because the ends of the optical fiber have to be processed to obtain an appropriate light entry surface for the light, but also because this assembly may be too fragile in some installation situations. The movements of the light entry segment in relation to the light entry surface on the optical fiber may have negative effects on the properties of the lighting device, reducing the homogeneity of the light.

### BRIEF SUMMARY OF THE INVENTION

It is therefore the object of the present invention to create a lighting device and a simple, quick, and inexpensive method for the production thereof, with which a durable connection and homogenous light distribution are obtained.

Because the at least one end of the light-conducting fiber and the at least one longitudinal segment are materially bonded to one another to form the light transfer region along the longitudinal extension, there is the advantage that the end or ends of the light-conducting lateral segment do not need to be processed. It is also not necessary to shorten an end such that the light-conducting fibers can be bundled together to obtain a light entry surface, nor is it necessary to obtain an optically clean connection through polishing. Because the end is connected to the longitudinal segment in an injection molding process, there is no need for any type of post-processing of the ends of the light-conducting fibers. There is also very little probability of the end surfaces becoming contaminated during to the production process. The connection therefore results in an integral unit, forming a mechanically durable component.

The lateral segment is formed by a fiber-optic fabric composed of the at least one light-conducting fiber, such that the interior of the vehicle is lit with a large surface area that does not have to alter the appearance of the interior. A large surface area structure is understood to be a lateral segment that is flat, such that its depth is substantially thinner than its length or width. If the lateral segment is formed by numerous light-conducting fibers, there is not only greater freedom with regard to its design, it is also possible to light the interior more brightly.

In one advantageous design, the at least one light-entry surface forms an optical element along the length of the longitudinal segment, which is designed as a diffusing element, focusing lens, and/or mixing lens. This results in an optimal light entry into the longitudinal segment and through the light transfer region into the lateral segment, such that the light is conducted efficiently and with low losses. If the optical element is a mixing lens, it also improves the homogeneity of the color mixture when RGB-LEDs are used. Depending on how many light-conducting fibers there are, the light from the light source is focused or diffused in order to effectively enter the light transfer region.

In one development of the invention, a second longitudinal segment is formed at the second end of the at least one light-conducting fiber in the lateral segment, which also has at least one light entry surface for light from a light source along it length. This advantageously increases the brightness of the light while reducing the number of electrical connections for the light sources. This reduces weight and the amount of space necessary for installation.

The at least one cavity forming optical elements advantageously has concave, convex, or rod-shaped formations along its length. Consequently, the optical elements can be formed as an integral part of the longitudinal segment during the production process.

In another design, the injection molded longitudinal segment is subsequently processed to obtain the optical elements along its length. Advantageously, the hardened longitudinal segment can be subsequently processed, and the cavities can be formed without bulges or indentations.

The injection molding material can be a translucent or transparent material. If translucent material is used, there is no need for the at least one optical element, because the diffusion particles therein conduct the light from the light source into the lateral segment. When transparent material and optical elements are used, the lighting device is more effective.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIGS. 1A-1C show embodiments of a lighting device according to the invention.

FIG. 2 shows another embodiment of the lighting device according to the invention.

FIG. 3 shows a preferred embodiment of the lighting device according to the invention.

FIG. 4 shows a sectional view of an injection mold.

FIG. 5 shows the injection mold from above, with the lateral segment therein.

### DETAILED DESCRIPTION OF THE DRAWINGS

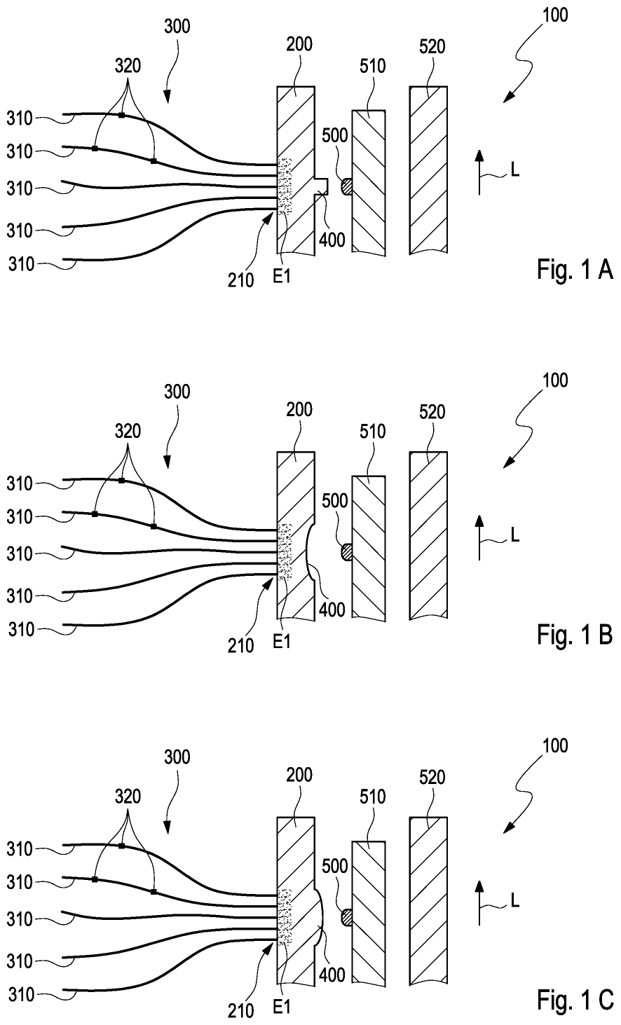

FIGS. 1A to 1C show a sectional view of various embodiments of the lighting device 100 according to the invention. The lighting device 100 contains a light source 500, a longitudinal segment, and a lateral segment 300 for lighting the interior. The light source 500 is on a printed circuit board 510 in a housing 520, and is dedicated to a light entry surface on the longitudinal segment 200. The light entry surface on the outer surface of the cylindrical longitudinal segment 200 in FIGS. 1A to 1C forms an optical element 400 with a variety of optical surfaces. The longitudinal segment 200 extends along the length L and can have a variety of cross sections. If it has an oval cross section, the spacing between the light source 500 and the light transfer region 210 is greater, thus improving color mixing when an RGB-LED is used. There is a lateral segment 300 containing light-conducting fibers 310 that is transverse to the longitudinal direction L. The light-conducting fibers 310 extend away from the longitudinal segment 200 from their first ends E₁ in a direction transverse to the longitudinal segment 200. The light from the light source 500 enters the longitudinal segment 200 through the optical element 400, and is conducted through the light-conducting fibers 310 through total internal reflection. Screens 320 can be placed on the light-conducting fibers 310 that direct the light into the interior. The light source 500 can be a light emitting diode (LED), or an assembly of light emitting diodes. These can be monochromatic light emitting diodes or colored light emitting diodes (RGB-LEDs). The lateral segment 300 can be an optical fiber fabric composed of light-conducting fibers 310, the first ends E₁ of which are materially bonded to the longitudinal segment 200, resulting in a light transfer region 210 indicated by grey shading in the drawings. The connection of the two segments takes place in an injection molding process in which the first ends E₁ of the fibers 310 are partially melted in the longitudinal segment 200. This depends on the temperature of the injection molding material, and the length of the injection molding process. The optical element 400 can be produced during the injection molding process, or can be formed through subsequent processing of the longitudinal segment 200. This takes place, for example, by processing the areas in question with a laser. The resulting optical element 400 is opposite the light transfer region 210, such that the light emitted by the light source 500 enters the lateral segment 300. The optical element 400 can be obtained during the injection molding process with convex, concave, or rod-shaped elements formed in the cavity. If an RGB-LED is used as the light source 500, a rod-shaped optical element 400 can be used to mix the colors, see FIG. 1A, which is formed during the injection molding process. The spacing between the RGB-LED and the light transfer region 210 is increased by the rod-shaped optical elements 400 that form the integral mixer, such that the colors are mixed homogenously. The rod-shaped optical element 400 can have a variety of cross sections, e.g. round, square, rectangular, and in particular, it can have a polygonal cross section. This results in a uniform color impression for the observer in the interior over the entire surface of the lateral segment 300. FIG. 1B shows a concave optical element 400, bowed inward toward the light transfer region, forming a diffusing element, and FIG. 1C shows a convex optical element 400, which is bowed outward toward the light source 500, forming a focusing lens. The geometry of the optical element 400 depends on the light source 500 and the number of light-conducting fibers 310, or the size of the light transfer region 210, with regard to whether the light is to be diffused, focused, or mixed. The light emission from the lateral segment 300 can be obtained with deflection elements 320 for an intended light distribution, which are placed on or within the light-conducting fibers 320 in the lateral segment 300. Only a few optical interference points in the form of deflection elements 320 are indicated in the drawings, as examples thereof. The total internal reflection is disrupted at these points, such that the light exits the fibers 320. The light can also be emitted from the lateral segment 300 into the interior through an activation of the light-conducting fibers 310, e.g. using brushes.

In a preferred exemplary embodiment, the lateral segment 300 is a fiber-optic fabric containing fibers for, or similar to those in, fabrics, into which the flexible light-conducting fibers 310 are woven. The fabric extending laterally away from the longitudinal segment 200 is flat, and the light-conducting fibers 310 are drawn out of the fabric such that their ends E₁ can be melted to part of the longitudinal segment 200, thus forming the light transfer region 210. A protective sleeve can be placed over these transparent plastic fibers 310 such that they conduct the light with total internal reflection and illuminate the interior.

Because the light transfer region 210 not only forms a mechanical connection, but also transfers light, this region serves two purposes, such that there is no need for an additional component with which the two segments are connected. There is also no need for post-processing, such as cutting and/or polishing the ends of the fibers 310.

In this exemplary embodiment, the lateral segment 300 is a flat fabric. Because the longitudinal segment 200 and the lateral segment 300 are materially bonded to one another at the light transfer region 210, the light-conducting fibers 310 do not need to be crimped, as is the case in the prior art, to obtain a strand with a light entry surface. The remaining fabric also does not need to be trimmed in order to bundle the fibers 310. These disadvantages are eliminated by the light transfer region 210 obtained when the two segments are bonded together in the injection molding process.

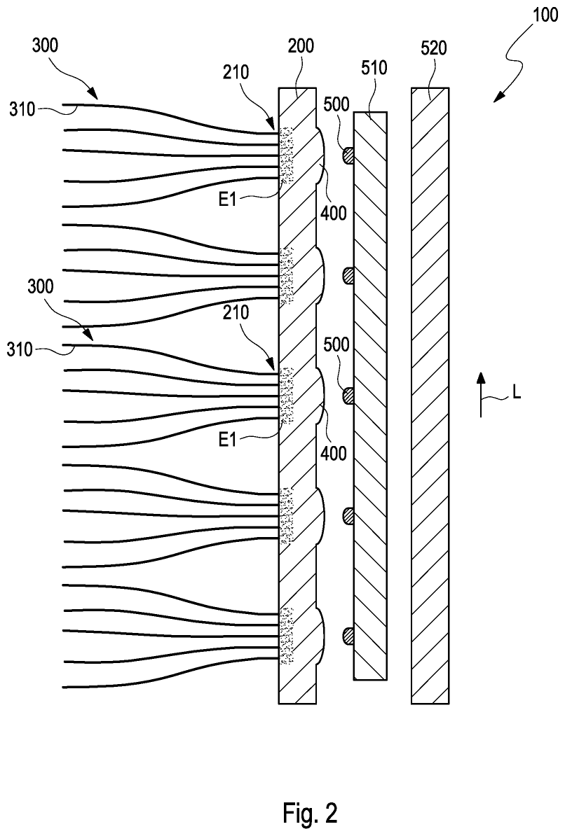

A preferred embodiment of the lighting device 100 according to the invention is shown in FIG. 2. The cylindrical longitudinal segment 200 is connected to the lateral segment 300 in sections along its length L at the light transfer regions 210. The optical elements 400 also form light entry surfaces opposite the light transfer region 210 along the length L of the longitudinal segment 200 in this exemplary embodiment, through which the light emitted from the light source 500 enters the lateral segment 300. Merely by way of example, the optical elements 400 here are formed by convex bulges. The lateral segment 300 can be a flat fabric, into which the flexible, light-conducting fibers 310 are woven, such that a door panel or ceiling upholstery can be obtained to form a lighting textile for a motor vehicle. The light sources 500 along the longitudinal segment 200, each of which is dedicated to a light entry surface, can be monochromatic or multi-colored LEDs, such that the interior lighting of a vehicle results in an attractive ambient lighting. By placing numerous light sources 500 along the longitudinal segment 200, in addition to being able to adjust the color, or obtain dynamic multi-colored lighting, the brightness can also be increased.

The ends E₁ of numerous light-conducting fibers 310 are combined along the length L of the longitudinal segment 200 to form the light transfer regions 210 through the material bonding thereto. Each of the light transfer regions 210 is opposite a light source 500, and the light therefrom enters them through light entry surfaces formed by optical elements 400. The light sources 500, which are spaced apart, can be of different types, e.g. alternating monochromatic colored lights, such that one light source 500 emits red light, and the other emits blue light.

Special color effects can be generated by dedicating the different light sources 500 to the respective light entry surfaces, which are also spaced apart along the length L.

The material from which the light-conducting fibers 310 is made can also be a transparent plastic, like that of the injection molding material, or it can be translucent, containing diffusing particles.

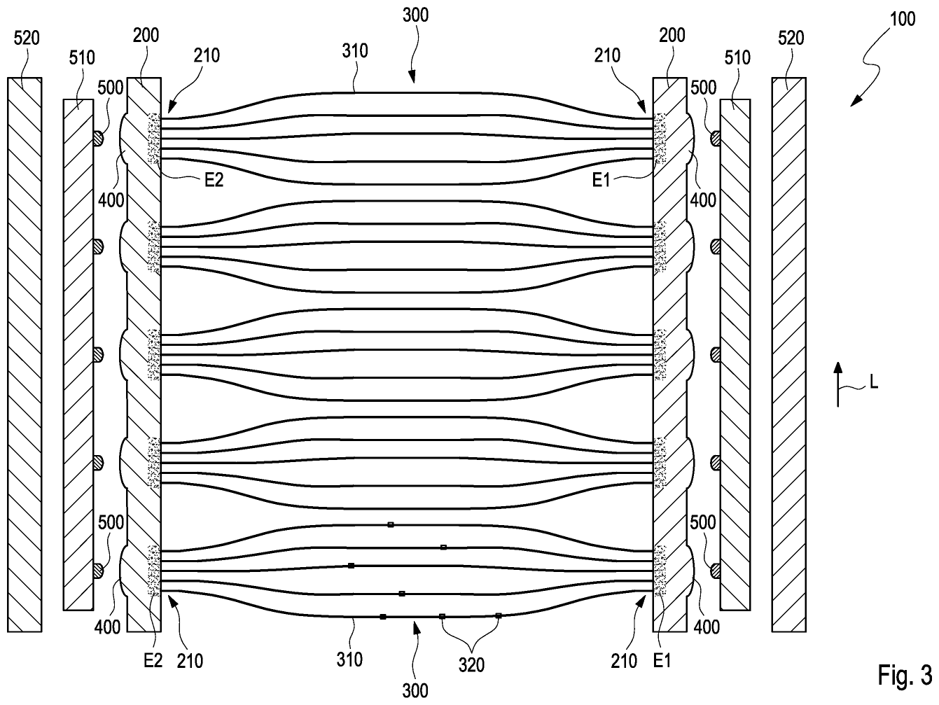

The preferred exemplary embodiment of the lighting device 100 according to the invention shown in FIG. 3 has numerous lateral segments 300 that are spaced apart, containing light-conducting fibers 310, which are located between two injection molded longitudinal segments 200. The light-conducting fibers 310 have a first end E₁ and a second send E₂. The first ends E₁ are materially bonded to a first longitudinal segment 200 at the light transfer regions 210, and the second ends E₂ are materially bonded to a second longitudinal segment 200 at the associated light transfer regions 210. Each light transfer region 210 is opposite a light entry surface formed by an optical element 400 in this exemplary embodiment as well, where the light from the dedicated light source 500 enters. Because the fibers 310 are melted to the injection molding material forming the longitudinal segment 200 at the light transfer regions 210, there is very little loss when the light is transferred to the lateral segment 300. With a targeted arrangement of deflection elements 320, special lighting effects can be obtained in this exemplary embodiment as well. The light emitted by the light sources 500, which can be monochromatic or multi-colored, results in a lighting of the interior by the light emitted from the lateral segment 300 with this preferred exemplary embodiment, with a minimum of electrical connections for the light sources 500. The light sources 500, which are also placed on printed circuit boards 510 or a semiconductor chip in the housings 520 here, are spaced apart from the respective optical elements 400.

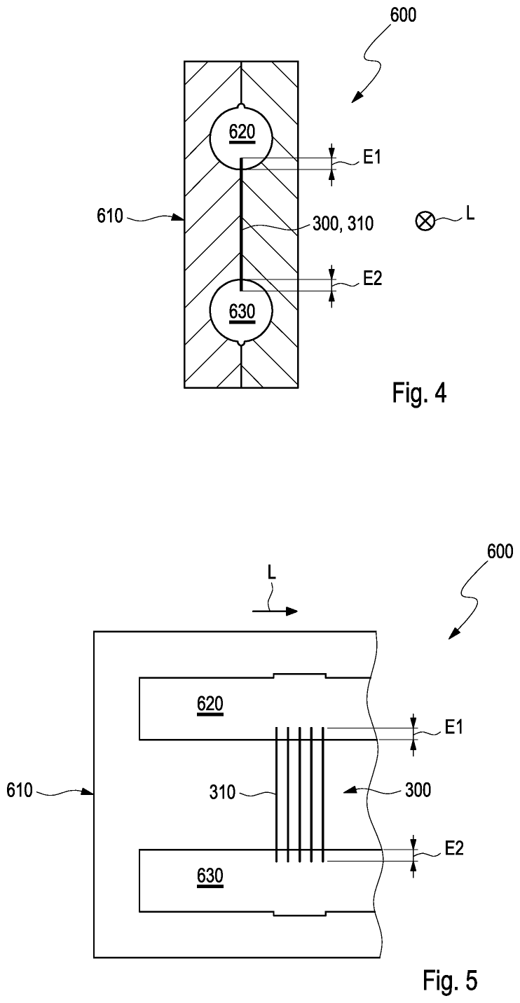

FIGS. 4 and 5 show an injection mold 600 with which a preferred embodiment of the lighting device 100 according to the invention can be produced with the method according to the invention. One part 610 of the mold can contain a first cavity 620 and a second cavity 630, into which the injection molding material can be injected. A transparent material is preferably used for the production of the light-conducting longitudinal segment 200, which is similar to the material used for the light-conducting fibers 310 with regard to its optical properties, e.g. silicone, PMMA, or PC. The lateral segment 300, with the light-conducting fibers 310 in which the light experiences total internal reflection, is placed in the mold 610 such that the first ends E₁ of the light-conducting fibers 310 extend into the first cavity 620. The lateral segment 300 is flat, such that the two ends E₁ and E₂ are in the same plane, and it is thinner than the cross section of the cylindrical longitudinal segment 200. This results in a homogenous mixing of the light before it enters the lateral segment. If two longitudinal segments 200 are formed on the lateral segment 300 in the injection molding process, an injection mold 600 with a second cavity 630 is provided, into which the second ends E₂ of the light-conducting fibers 310 of the lateral segment 300 extend. The cavities 620, 630 in which the longitudinal segments 200 are formed can have different shapes, resulting in different cross sections for the longitudinal segments 200. The optical elements 400 can be formed in the injection molding process, the shapes of which depend on the mold 610 that is used, in order to focus the light into the light transfer regions. In this exemplary embodiment, convex bulges in the cavities 620, 630 form the optical elements 400. The cavities 620, 630 can also have concave recesses or rod-shaped forms along their length L, which can also have different cross sections, to obtain an integrated mixing lens, such that the optical elements 400 are formed as integral parts of the longitudinal segment 200, in order to focus, diffuse, or mix the light accordingly. The optical elements 400 can also be formed subsequently on the longitudinal segments 200 through hot stamping or laser processing, in which case the cavities 620, 630 have no bulges or recesses. When the injection molding material is injected into the cavities 620, 630, the ends E₁, E₂ are melted and bonded to the injection molding material, such that a material bonding is obtained that forms the light transfer region 210, lying opposite the light entry surface. Because the light transfer region 210 forms a smooth transition from the longitudinal segment 200 to the lateral segment 300, light is transferred without optical interference, resulting in a more efficient lighting device 100. This use of an injection molding process for the production of the lighting device 100 is an inexpensive and time-saving production process.

If a diffusing injection molding material is used, there is no need for the optical elements 400, because the diffusing particles contained therein focus the light from the light sources 500 through the light transfer region 210 into the lateral segment 300, taking a lower efficiency into account.

### List of Reference Symbols

100 Lighting device

200 longitudinal segment

210 light transfer region

300 lateral segment

310 fibers

320 deflection element

400 optical element

500 light source

510 printed circuit board

520 housing

600 injection mold

610 mold part

620 first cavity

630 second cavity

L length

E₁ first end

E₂ second end

1. A lighting device for lighting an interior, the lighting device comprising:
at least one cylindrical longitudinal segment that extends along a length (L);
at least one lateral segment extending away from the longitudinal segment; and
at least one light source;
wherein the at least one longitudinal segment has at least one light entry surface along its length (L) and at least one light transfer region through which the light is conducted to the lateral segment,
wherein the at least one light entry surface has a dedicated light source,
wherein the at least one light transfer region and the at least one light entry surface lie opposite one another,
wherein the at least one lateral segment is flat, and has at least one light-conducting fiber through which light is emitted into the interior, which has a first end (E₁) and a second end (E₂), and
wherein at least one of said first end or said second end of the light-conducting fiber and the at least one longitudinal segment are materially bonded to one another along the length (L) to form the light transfer region.

2. The lighting device according to claim 1, wherein the lateral segment is a fiber-optic fabric containing the at least one light-conducting fiber.

3. The lighting device according to claim 1, wherein the at least one light entry surface forms an optical element, wherein the at least one optical element forms a diffusing element, focusing lens, and/or mixing lens.

4. The lighting device according to claim 1, wherein a second longitudinal segment is formed on the second end (E₂) of the at least one light-conducting fiber in the lateral segment, wherein the second longitudinal segment also has at least one light entry surface along its length (L) for the light from a light source.

5. A method for the production of a lighting device, the method comprising the following steps:
providing an injection mold that has at least one cylindrical cavity, with a length (L), which is to be filled with an injection molding material;
providing a flat lateral segment that contains at least one light-conducting fiber, which has a first end (E₁) and a second end (E₂);
placing the at least one end (E₁, E₂) of the light-conducting fiber into the at least one cylindrical cavity along the length (L);
injecting the injection molding material into the at least one cylindrical cavity to obtain a longitudinal segment and to obtain at least one light transfer region between the lateral segment and the longitudinal segment; and
placing at least one light source along the length (L) of the longitudinal segment, which lies opposite the light transfer region.

6. The method according to claim 5, wherein the at least one cavity contains concave, convex, and/or rod-shaped forms along its length with which the optical elements are formed.

7. The method according to claim 5, wherein the injection molded longitudinal segment is subsequently processed to obtain optical elements along its length (L).

8. The method according to claim 6, wherein the at least one optical element is placed in the beam path from the light source, and the at least one light transfer region lies opposite it.

9. The method according to claim 5, wherein diffusing or transparent material is used for the injection molding material.

10. The method according to claim 5, wherein the second end (E₂) is placed in a second cavity and injection molding material is injected therein to form a second longitudinal segment and at least one more light transfer region.
